(19) United States
(12) Patent Application Publication
(10) Pub. No.: US 2018/0083999 A1
(43) Pub. Date: Mar. 22, 2018

(54) SELF-PUBLISHED SECURITY RISK MANAGEMENT

(71) Applicant: BitSight Technologies, Inc., Cambrdige, MA (US)

(72) Inventor: Mathew S. Cherian, Bedford, MA (US)

(21) Appl. No.: 15/271,655

(22) Filed: Sep. 21, 2016

(51) Int. Cl. H04L 29/06

(52) U.S. Cl. CPC H04L 63/1433; H04L 63/20

(57) ABSTRACT

A method and system for creating a security rating for a sub-entity of an entity. The security rating of the sub-entity is calculated based on an entity map provided by a representative of the entity. The sub-entity map details which assets of an entity belong to one or more of its sub-entities. It is advantageous to know the security rating of a sub-entity of an entity when an at-risk company is making a decision on whether or not to conduct business with a sub-entity whose security rating may different than that of the entity to which it belongs.

### TECHNICAL FIELD OF THE INVENTION

The invention relates generally to providing risk assessment scores for entities and, more particularly, cyber-security risk scores for entities and sub-entities based on various groupings of assets and events attributed to the entities and sub-entities.

### BACKGROUND

Security risks faced by an entity, for example information security risks, often include security risks associated with other entities with which it communicates or collaborates. The first entity may evaluate the magnitude of the risks associated with the other entities to make decisions about its relationships with those other entities. While knowledge of these potential risks provides significant insight into the viability of an entity or organization, often there are certain composite parts of an entity that contribute to an entity's risk profile more than others. Currently available technologies do not allow this first entity to evaluate the risk associated with those other entities or their subsidiaries, or sub-entities, at a granular level based on these composite parts.

### SUMMARY OF THE INVENTION

The security risk management that we describe here may encompass one or more of the following (and other) aspects, features, and implementations, and combinations of them.

In general, in an aspect, a method is provided for generating a cyber-security rating for constituent groups of entities. The method uses publicly available online information to automatically identify technical assets belonging to entities which contribute to the respective entities' cyber-security characteristics. Non-public information may be entered by a user, who is legally associated with the entity, via an online portal associating technical assets with one or more sub-entities of an entity. The method may use this information to provide a cyber-security rating for the one or more sub-entities of the entity.

In some embodiments the rating associated with a sub-entity is identified as being provided by the entity. These sub-entities reflect one or more of a geographical group, a business structure grouping, or an asset type grouping. In some embodiments, publicly available online information may be commercially available. The online portal may include an application programming interface. The online portal may receive information that is manually input by a user or it may receive information from an automated update process.

A system is provided for generating a cyber-security rating for constituent groups of entities. The system includes a first processor and a first memory in electrical communication with the first processor. The first memory includes instructions that can be executed by a processing unit including the first processor or a second processor, or both. The processing unit may be in electronic communication with a memory module that includes the first memory or a second memory, or both.

The instructions program the processing unit to use publicly available online data to identify technical assets belonging to entities which contribute to the respective entities' cyber-security characteristics. The processing unit receives non-public information may be entered by a user, who is legally associated with the entity, via an online portal associating technical assets with one or more sub-entities of an entity and uses this information to provide a cyber-security rating for the one or more sub-entities of the entity. In some embodiments, publicly available online information may be commercially available. The online portable may include an application programming interface. The online portal may receive information that is manually input by a user or it may receive information from an automated update process.

### BRIEF DESCRIPTION OF THE FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a block diagram of an example environment for assigning a security rating and a confidence score to one or more sub-entities that are attributed to an entity.

FIG. 2 is a block diagram of the relationship between an entity and its one or more sub-entities and their assets.

FIG. 3 a block diagram of an example environment 300 of an analysis system 302 receiving traces of activities of an online user who is associated with a sub-entity of an entity.

FIG. 4 is an example of a website interface 400 for displaying the security rating of a sub-entity associated with an entity.

FIG. 5 is flow diagram of the process of determining a security rating of a sub-entity on an entity.

FIG. 6 is a block diagram of an example computer system.

### DETAILED DESCRIPTION

In the system and techniques described herein, an individual, company, government organization or other entity may obtain and use security analysis data from an analysis system to determine its own security risk or the potential security risks that it may be exposed to by interacting with (e.g., doing business with) a different entity and/or its subsidiaries. The risks may result from communicating or having a relationship with such an entity, especially if the interaction involves sensitive or confidential information. When references are made herein to an “entity” or “entities” it is meant broadly to include, for example, individuals or businesses that communicate electronically with other individuals or businesses and potentially share electronic data. A reference made to a “subsidiary” or to a “sub-entity” of an entity is meant broadly to include virtually any grouping of locations, assets (physical, technical, virtual, etc.), people, teams, business units, legal entities, product teams, etc. The information security analysis data may be used by an entity to identify potential areas of improvement for its own security risk, to determine if or to what extent sensitive information should or should not be provided to another entity that is associated with unacceptable security vulnerabilities. References to “information security risk” as used herein are meant broadly to include, for example, any kind of security risk that may be evaluated using the system and techniques.

The analysis system may receive and analyze technical and/or non-technical data or assets to determine a security rating of an entity and, by extension, its one or more sub-entities. When references are made herein to “technical data” it is meant broadly to include, for example, IP address blocks, domain names, autonomous system (AS) numbers, email addresses (if hosted outside the entity), and general technologies used (e.g., firewalls, switches, routers, intrusion detection systems, intrusion prevention systems, etc.). When references are made herein to “non-technical data” it is meant broadly to include, for example, physical addresses, employee count, stock ticker symbols, alternative company names (e.g., in other languages), revenue, organizational structure, hosting service providers, logo, company description, and critical staff (including names and email addresses). The term “security rating” is used in its broadest sense to include, for example, any kind of absolute or relative ranking, listing, scoring, description, or classification, or any combination of them, of an entity or sub-entity with respect to characteristics of its security state. For example, the analysis system may identify an entity associated with the received data, map the received data to attributes for the entity, such as contact information and the number of employees employed by the entity, the industry of the entity, its geographic location(s), and determine a security rating for the entity using the mapped data.

An example of received data may include traces of online activity associated with an entity based, for example, on logs of online activity of employees of the entity or settings of servers that host data for the entity to determine a security rating for the entity.

The online activity and the settings of servers may include data that is publicly or commercially available. For example, the online activity may include public interactions of employees with social networking systems, publicly available information associated with cookies stored on a device operated by an employee, or publicly available security settings for a mail server that hosts the entity's electronic mail. The publicly available data may be retrieved from a Domain Name Server or an industry intelligence company to name two examples.

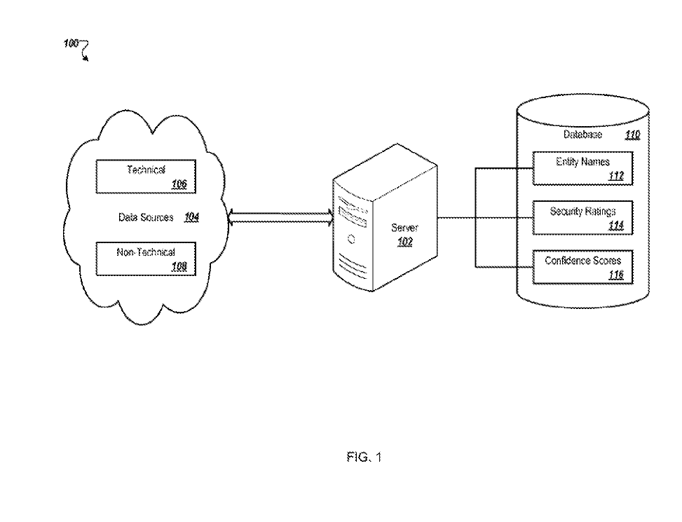

FIG. 1 is a block diagram of an example environment 100 for assigning a security rating and a confidence score to one or more sub-entities that are attributed to an entity. The environment 100 includes a server 102 that receives data from technical data sources 104. The technical data sources 104 include technical assets 106 and non-technical assets 108, described in more detail below.

The server 102 acquires and analyzes data from the technical assets 106 and the non-technical assets 108 to identify association(s) between the data and the entities. For example, the server 102 selects a subset of the data received from the technical assets 104, identifies the entity associated with the subset of the data, and creates a mapping between the subset of the data and the identified entity. Assets may map to one or more entities and an entity may own multiple assets.

After an asset has been mapped to an entity, the server 102 may use the mapping to associate event data belonging to the asset with the entity. Event data may include, for example, information about a domain name system (DNS) attack on a server belonging to an entity. Both technical 104 and non-technical assets 108 may possess event data that can be mapped to the entity owning the assets.

An automatic analysis process to map non-technical event data to an entity may include the analysis system automatically identifying data associated with an entity based on data received from an asset, without input or intervention from an operator, e.g., an operator of the analysis system. This operator may sometimes be referred to as a mapper. In some examples, the automatic analysis process may include collecting data from the assets and approving proposed portions of a mapping between data received from the assets and attributes of an entity.

The manual analysis process may include presentation of event data to an operator of the analysis system, e.g., a computer executing the analysis system, where the operator maps associations between the received data and one or more entities.

The semi-automatic analysis process may include a combination of the automatic analysis process and the manual analysis process. For example, the automatic analysis process may map some of the received data to an entity and present information associated with the mapping to an operator for approval. In addition, the operator may acquire and review received data, and manually map event data to a target entity.

The server 102 may store some or all of the received data in a database 110. For example, the server 102 may store entity names 112, security ratings 114 for the entities identified by the entity names 112, and confidence scores 116 in the database 110, where each of the confidence scores 116 corresponds with one of the security ratings 114. As described in greater detail below, the database 110 may also store sub-entity listings and associations among the sub-entities and entities.

The confidence scores 116 may represent the confidence of a corresponding security rating, from the security ratings 114. For example, each of the confidence scores 116 may represent the confidence of the server 102 in the corresponding security rating. The server 102 may use any appropriate algorithm to determine the security ratings 114 and the corresponding confidence scores 116 or other values that represent a security rating of an entity or sub-entity.

An entity may use one of the security ratings 114 and the corresponding one of the confidence scores 116 to determine its own security rating or the security rating of another entity with which the entity may communicate. For example, if the entity itself has a poor security rating, the entity may determine steps necessary to improve its own security rating and the security of its data. The entity may improve its security to reduce the likelihood of a malicious third party gaining access to its data or creating spoofed data that is attributed to the entity or an employee of the entity.

An entity may determine whether or not to communicate with another entity based on the other entity's security rating. Sometimes in this discussion, the entity being rated is referred to as the “target entity” and the entity using the rating is referred to as the “at-risk entity.” For example, if the target entity has a low security rating, the at-risk entity may determine that there is a greater likelihood that documents sent to the target entity may be accessed by a user who is not authorized to access the documents compared to documents sent to a different target entity that has a higher security rating. A low security rating may indicate that a target entity has historically received numerous cyber-attacks.

The target entity may have several subsidiaries, or sub-entities, differing from each other in geographic location, business function, asset types, employees, among others. Different subsidiaries may have differing security ratings contributing in various amounts to the target entity's overall security rating. For example, an entity may only communicate with one sub-entity of an entity, but the entity's overall security rating is not reflective of the security rating of the individual sub-entity with which the entity communicates. In a further example, let sub-entities A1, A2, and A3 belong to target entity A with sub-entity A1 having the lowest security rating, sub-entity A3 having the highest security rating, and sub-entity A2 having a security rating between that of sub-entities A1 and A3. The overall security rating of entity A may be some combination or average of the security ratings of sub-entities A1, A2, and A3 as determined by the server. An at-risk entity, entity B, may be interested in conducting business with entity A. However, upon viewing entity A's security rating, it may be in entity B's best interest to conduct business with sub-entity A3, instead of with entity A or its other sub-entities A2 or A1, since sub-entity A3 has the highest security rating. This may be due, in part, to geographical locations of the sub-entities, different technical infrastructure, historical transactions (e.g., A1 may have been acquired from another entity with less rigorous security practices), as well as other reasons.

A subsidiary map may illustrate the organization of the target entity and list the assets belonging to each subsidiary. A subsidiary map may include non-public information that is not otherwise available unless provided by a representative of the target entity. In this discussion, “representative” refers to a user who is able to provide more detailed information about a target entity and therefore may be able to provide a subsidiary map. In some cases, the representative may be a legal representative of the entity (and provide proof thereof) such that the confidence of their subsidiary map is high, whereas in other cases the representative may simply attest to their authority without providing any specific documentation or other evidence of authority. Additionally, the representative of an entity may provide information on an entity's internal hosts that do not have an external IP address and therefore cannot be identified. The analysis system may use this subsidiary map to produce a rating for each sub-entity of the target entity. These ratings may be labeled as “self-published” when viewed by an at-risk entity, denoting that they were produced using a subsidiary map provided by the target entity itself. Optionally, in some embodiments, an entity may elect to keep the subsidiary map and associated security ratings viewable only to itself, such that none of the entity's subsidiary map data is publically available. In other cases, the entity may selectively determine whether a particular at-risk entity requesting security ratings have access to the subsidiary map. For example, the entity may be trying to win a contract from the at-risk entity, and allow that particular at-risk entity to see its subsidiary may and the associated security ratings.

The at-risk entity may compare the security ratings of two competitive target entities or sub-entities to determine the difference between the security ratings of the competitors and with which of the competitors the entity should communicate or engage in a transaction, based on the security ratings. For example, the at-risk entity may require a third party audit and select one of the two competitors for the audit based on the security ratings of the competitors, potentially in addition to other factors such as price, recommendations, etc.

In some implementations, the server 102 includes the database 110 which is stored in a memory included in the server 102. In others, the database 110 is stored in a memory on a device separate from the server 102. For example, a first computer may include the server 102 and a second, different computer may include the memory that stores the database 110. The database 110 may be distributed across multiple computers. For example, a portion of the database 110 may be stored on memory devices that are included in multiple computers.

The server 102 may store data received from the data sources 104 in memory. For example, the server 102 may store data received from the data sources 104 in the database 110 or in another database.

The security rating for an entity may be associated with the security of electronic data of the entity. In others, the security rating for an entity is associated with the security of electronic and non-electronic data of the entity.

The server 102 may identify an entity based on a request for a security rating for the entity from a third party. The server 102 may identify the entity automatically by determining that the server 102 has received more than a predetermined threshold quantity of data for the entity and that the server 102 should analyze the data to determine the entity's scores. In some implementations, an operator of the server 102 may identify the entity by providing the server 102 with a list of entities for which the server 102 should determine the scores. In some examples, the list of entities may include a predetermined list of entities, such as Fortune 600 or Fortune 1000 companies.

The server 102 may identify a target entity that is not currently assigned a security rating or an entity that was assigned a previous security rating based on new or updated data for the entity or based on a request for an updated security rating, e.g., from an at-risk entity.

In determining a security rating for an entity, the server 102 may receive data from the data sources 104, including data for the identified entity. For example, the server 102 may identify a subset of the received data that is associated with the identified entity. The subset of the received data may be associated with the identified entity based on each of the distinct portions of the subset including the name of the identified entity, e.g., “Sample Entity,” or a name or word associated with the identified entity, e.g., the name of a subsidiary, an acronym for the identified entity, or a stock symbol of the identified entity, among others.

The server 102 may map the subset of the received data that is associated with the identified entity to various attributes for the identified entity. Attributes may include number of employees and industry, among others. For example, if the server 102 determines that the identified entity currently employs sixty-three employees, the server may assign the value of sixty-three to an “employees” attribute of the identified entity in the database. In some examples, the server 102 may determine one or more industries for the identified entity, such as “Computer Networking.” The industries may represent the type of products and/or services offered by the identified entity. Standard industry codes can be used for this purpose.

As the server 102 receives portions of the subset of data, if the server determines that each of the portions is associated with the identified entity, the server 102 maps the received portions to the attributes for the identified entity. For example, the server 102 may automatically map data to an “employees” attribute based on received data and then automatically map data to an “industry” attribute.

In some examples, the server 102 may update one or more of the attributes as the server 102 receives additional data associated with the identified entity. For example, the server 102 may determine that the identified entity sells “computer networking products” and then determine that the identified entity also offers “computer networking services.” The server 102 may associate the industry “computer networking products” with the identified entity first based on the data that indicates that the identified entity sells computer network products, then associate the industry “computer networking services” with the identified entity based on the data that indicates that the identified entity also offers computer networking services.

Based on the data mapped to the attributes for the identified entity, the server 102 determines one or more scores for the identified entity. These scores may be a security rating and a corresponding confidence score for the identified entity “Sample Entity.”

The server 102 may use some or all of the attributes for the identified entity when determining the score for the identified entity. For example, the server 102 may use an industry assigned to the identified entity as one factor to determine the security rating of the identified entity.

The server 102 may determine weights for the attributes where the weights represent the influence of the corresponding attribute on the security rating. For example, the number of employees employed by an entity may be assigned a greater weight than the industries of the products or services offered by the entity.

The weights may vary based on the values of the attributes. When an entity or sub-entity has few employees, a weight corresponding to the number of employees may be smaller than if the entity or had a greater number of employees. The server 102 may provide the security rating and the corresponding confidence score of the identified entity to one or more other entities. For example, an at-risk entity may request the security rating and the corresponding confidence score for the identified target entity as part of a security analysis process for the identified target entity by the at-risk entity.

A verified legal representative of an entity may provide the entity analysis company with a subsidiary map of an entity, which outlines the organization of the sub-entities and the assets belonging to each sub-entity. The representative may input the subsidiary map via a user interface. The server 102 may provide a score for each sub-entity listed in the provided subsidiary map, which may be a percentage of the entity's score.

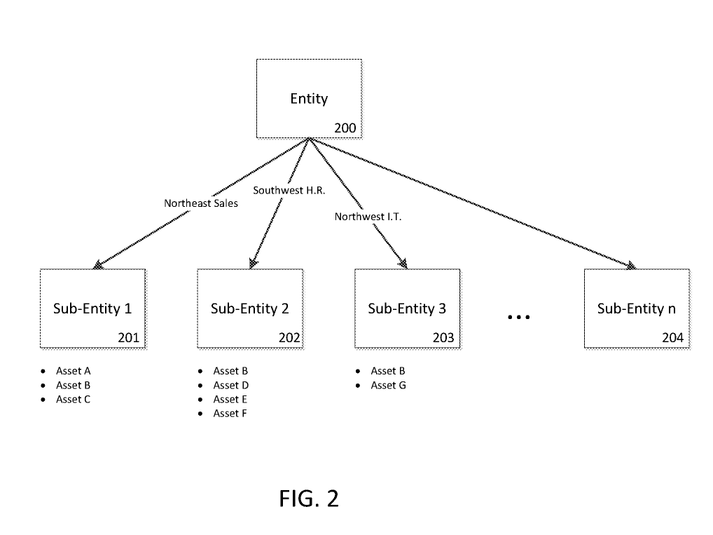

FIG. 2 depicts a map of an entity 200 to its sub-entities 201, 202, 203. For example these sub-entities may be organized by geographical region and business function, such as Northeast Sales, Southwest Human Resources, and Northwest I.T. Each sub-entity may have a list of assets, which may or may not be shared between it and the entity's other sub-entities. An asset, for example, Asset A, may contain an Internet Protocol address or range of Internet Protocol addresses associated with the sub-entity, Sub-Entity 1 201 to which it belongs.

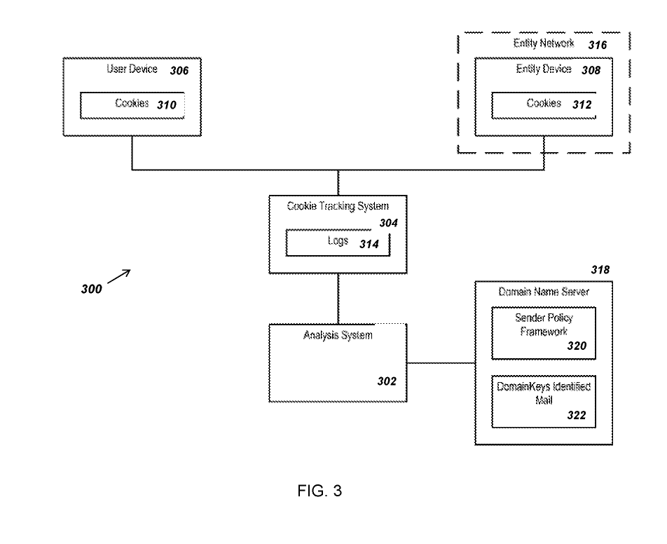

FIG. 3 is a block diagram of an example environment 300 of an analysis system 302 receiving traces of activities of an online user who is associated with a sub-entity of an entity. Asset A may be an IP address or range of IP addresses associated with a sub-entity of an entity. The relationship between Asset A, the sub-entity, and the entity may be defined by a subsidiary list given to the entity analysis company by a representative of the entity.

A cookie tracking system 304 may provide a user device 306 and a sub-entity device 308 with cookies 310 and 312, respectively, and may record information about the cookies 310 and 312 in one or more logs. In some examples, Asset A 314 may include an IP address of the user device 306 when the user device accesses content, such as an advertisement or a website.

The analysis system 302 may receive a portion of the logs, such as data indicating that the user device 306 accessed a particular website from a first IP address, e.g., based on a cookie associated with an advertisement, and that the user device 306 accessed the same particular website from a second IP address. In some implementations, the data does not include any identification information of the particular user device.

The analysis system 302 may determine that either the first IP address or the second IP address are associated with a sub-entity, e.g., based on an assignment of a block of IP address including the first or second IP address to the sub-entity, that the other IP address is not associated with the sub-entity, and that the sub-entity has a “bring your own device” policy that allows employees of the entity and/or sub-entity to access an entity and/or sub-entity network 316 with their own devices, e.g., the user device 306.

The analysis system 302 may determine that the sub-entity device 308 is a portable device, e.g., a laptop or a tablet, by identifying a first IP address associated with the cookies 312 that is also associated with a sub-entity and a second IP address associated with the cookies 312 that is not associated with the sub-entity. The analysis system 302 may be unable to differentiate between a “bring your own device” such as the user device 306 and the entity device 308 when an operator of the sub-entity device 308 connects the entity device 308 to a network other than the sub-entity network 316.

The analysis system 302 may use network policy information of a sub-entity to determine a security rating for the sub-entity or sub-entities associated with Asset A 314. For example, the analysis system 302 may use a determination whether the sub-entity has a “bring your own device” policy or allows employees to bring the sub-entity device 308 home when calculating a security rating for the sub-entity.

The analysis system 302 may determine whether the user device 306 or the sub-entity device 308 are not fully secure, e.g., based on potentially malicious activities of the user device 306 or the sub-entity device 308, and about which the operator of the device likely does not know. For example, the analysis system 302 may determine that the user device 306 was recently infected with malware and that the sub-entity is not enforcing sufficient security policies on devices that can access the entity and/or sub-entity network 316, and assign the sub-entity a lower security rating.

The analysis system 302 receives information from a Domain Name Server 318 or a passive Domain Name Server that indicates whether a mail server that hosts an entity or sub-entity's electronic mail enforces one or more email validation methods. For example, the analysis system 302 may query the Domain Name Server 318 or a passive Domain Name Server to determine whether email sent from the mail server includes malicious mail, e.g., spam, whether an email with a sender address that includes a domain of the sub-entity complies with a Sender Policy Framework 320, e.g., is sent from an authorized computer, and whether an email includes a signature that complies with DomainKeys Identified Mail 322.

The analysis system 302 may determine a security rating for a sub-entity based on the validation methods used by the mail servers of the sub-entity. For example, when the sub-entity uses one or more non-duplicative validation methods, the sub-entity may be assigned a higher security rating.

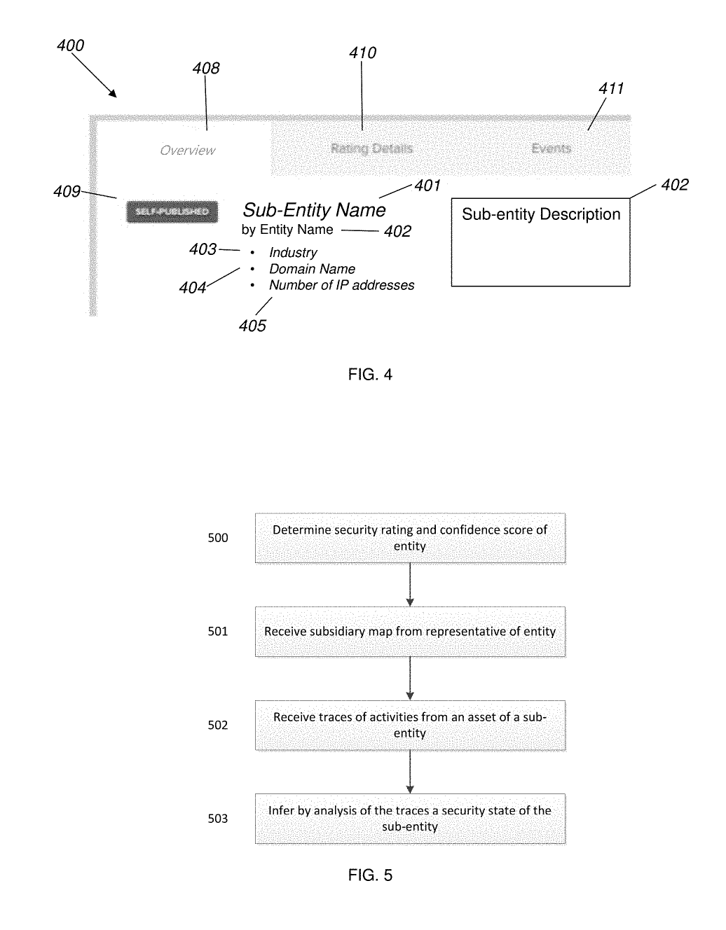

FIG. 4 is an example of a website interface 400 for displaying the security rating of a sub-entity associated with an entity. The interface may display the entity name 402, the industry 403, the domain name 404, the number of IP addresses associated with the sub-entity 405, and a brief description 406 of the sub-entity on an “Overview” tab 408. On this tab there may also be an icon 409 indicating that the sub-entity was identified as a result of a subsidiary map submitted by a representative of an entity. A “Ratings” tab may display the security rating and confidence score of the sub-entity and an “Events” tab 411 may display a log of cyber-security breach events linked to the sub-entity's IP addresses. These events may be, for example, similar to those described above in FIG. 3.

FIG. 5 is a flow diagram depicting the process of determining a security rating, receiving a subsidiary map from the representative of an entity, and determining the security rating of a sub-entity of that entity. For example, the process may be carried out by the server 102 from the environment 100 in FIG. 1.

As described above in FIG. 1, the server 102 determines a security rating and confidence score of an entity (500). A representative for that entity may submit a subsidiary map to the asset analysis company for the entity (501) describing the relationship between the entity and its sub-entities. As previously described, the subsidiary map contains non-public information that may not otherwise be determined without input from the representative. As described in FIG. 3, the server 102 uses the assets belonging to the sub-entity, as listed in the subsidiary map, to log the traces of activities of an online user or users associated with the sub-entity (502). The server 102 uses this log information among other data previously described to infer the security state and determine the security rating and confidence score of the sub-entity. This process may be repeated for each sub-entity listed in the subsidiary map of an entity.

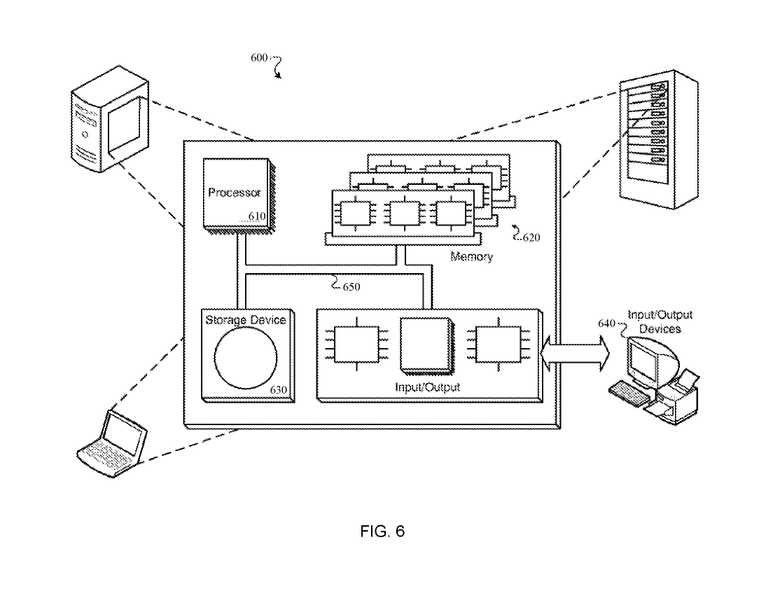

FIG. 6 is a block diagram of an example computer system 600. For example, referring to FIG. 3, the analysis system or a server forming a portion of the analysis system could be an example of the system 600 described here, as could a computer system used by any of the users who access resources of the environment 100 or the environment 300. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In some implementations, the processor 610 is a single-threaded processor. In some implementations, the processor 610 is a multi-threaded processor. In some implementations, the processor 610 is a quantum computer. The processor 610 is capable of processing instructions stored in the memory 620 or on the storage device 630. The processor 610 may execute operations such as the steps described above in reference to the process 500 (FIG. 5).

The memory 620 stores information within the system 600. In some implementations, the memory 620 is a computer-readable medium. In some implementations, the memory 620 is a volatile memory unit. In some implementations, the memory 620 is a non-volatile memory unit.

The storage device 630 is capable of providing mass storage for the system 600. In some implementations, the storage device 630 is a computer-readable medium. In various different implementations, the storage device 630 can include, for example, a hard disk device, an optical disk device, a solid-date drive, a flash drive, magnetic tape, or some other large capacity storage device. In some implementations, the storage device 630 may be a cloud storage device, e.g., a logical storage device including multiple physical storage devices distributed on a network and accessed using a network. In some examples, the storage device may store long-term data, such as the log 412 in the database 410 (FIG. 4), as well as the entity names 112 in the database 110 (FIG. 1). The input/output device 640 provides input/output operations for the system 600. In some implementations, the input/output device 640 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. A network interface device allows the system 600 to communicate, for example, transmit and receive data such as data from the data sources 104 shown in FIG. 1. In some implementations, the input/output device can include driver devices configured to receive input data and send output data to other input/output devices, e.g., keyboard, printer and display devices. In some implementations, mobile computing devices, mobile communication devices, and other devices can be used.

A server (e.g., a server forming a portion of the analysis system 302 shown in FIG. 3) can be realized by instructions that upon execution cause one or more processing devices to carry out the processes and functions described above, for example, storing the entity names 112 in the database 110 and assigning the entity names 112 corresponding security ratings 114 and confidence scores 116 (FIG. 1). Such instructions can include, for example, interpreted instructions such as script instructions, or executable code, or other instructions stored in a computer readable medium. A server can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although an example processing system has been described in FIG. 6, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as software for mapping data to entities and assigning security ratings and confidence scores to entities (FIGS. 1-6), can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server (e.g., forming a portion of the server 102) is a general purpose computer, and sometimes it is a custom-tailored special purpose electronic device, and sometimes it is a combination of these things.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

The terms and expressions employed herein are used as terms and expressions of description and not of limitation and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The structural features and functions of the various embodiments may be arranged in various combinations and permutations, and all are considered to be within the scope of the disclosed invention. Unless otherwise necessitated, recited steps in the various methods may be performed in any order and certain steps may be performed substantially simultaneously. Accordingly, the described embodiments are to be considered in all respects as only illustrative and not restrictive. Furthermore, the configurations described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method of generating a cyber-security rating for constituent groups of entities, the method comprising:
automatically obtaining, using at least one computer processor, publicly available online information comprising an identification of technical assets belonging to a plurality of entities, wherein events related to the technical assets contribute to cyber-security characteristics of the respective entities;
identifying non-technical assets belonging to the plurality of entities;
receiving, from a user via an online portal, non-public information inaccessible to a general public and comprising an identification of:
(i) an internal computer host among the technical assets belonging to one of the plurality of entities;
(ii) at least a portion of the non-technical and technical assets belonging to one or more sub-entities of the one of the plurality of entities; and
(iii) a relationship between the one or more sub-entities and the one of the plurality of entities; and
generating a cyber-security rating for the one or more sub-entities based on the non-public information.

2. The method of claim 1 in which the rating associated with a sub-entity is identified as being provided by the entity.

3. The method of claim 1 in which the non-technical assets contribute to cyber-security characteristics of the respective entities and identities of the entities associated with the respective technical assets comprise publicly available online information.

4. The method of claim 1 further comprising semi-automatically identifying relationships among non-technical assets and entities to which assets belong.

5. The method of claim 1 further comprising manually identifying relationships among non-technical assets and entities to which assets belong.

6. The method of claim 1 in which an event is a cyber-security breach.

7. The method of claim 1 in which the user is legally associated with the entity.

8. The method of claim 1 in which the sub-entity is related to multiple entities.

9. The method of claim 1 in which the sub-entities reflect one or more of a business unit structure, business relationship structure, geographical grouping, and an asset type grouping.

10. The method of claim 1 in which publicly available data comprises data that is commercially available.

11. The method of claim 1 in which the online portal comprises an application programming interface.

12. The method of claim 1 in which the online portal receives data manually entered by a user via electronic messaging.

13. The method of claim 1 in which the online portal receives data via an automated update process.

14. A system for facilitating identification of a device, the system comprising:
a first processor; and
a first memory in electrical communication with the first processor, the first memory comprising instructions which, when executed by a processing unit comprising at least one of the first processor and a second processor, and in electronic communication with a memory module comprising at least one of the first memory and a second memory, program the processing unit to perform operations comprising:
automatically obtaining, using at least one computer processor, publicly available online information comprising an identification of technical assets belonging to a plurality of entities, wherein events related to the technical assets contribute to cyber-security characteristics of the respective entities;
identifying non-technical assets belonging to the plurality of entities;
receiving, from a user via an online portal, non-public information inaccessible to a general public and comprising an identification of:
(i) an internal computer host among the technical assets belonging to one of the plurality of entities;
(ii) at least a portion of the non-technical and technical assets belonging to one or more sub-entities of the one of the plurality of entities; and
(iii) a relationship between the one or more sub-entities and the one of the plurality of entities; and
generating a cyber-security rating for the one or more sub-entities based on the non-public information.

15. The system of claim 14 in which the rating associated with a sub-entity is identified as being provided by the entity.

16. The system of claim 14 in which the non-technical assets contribute to cyber-security characteristics of the respective entities and identities of the entities associated with the respective technical assets comprise publicly available online information.

17. The system of claim 14, the operations further comprising semi-automatically identifying relationships among non-technical assets and entities to which assets belong.

18. The system of claim 14, the operations further comprising manually identifying relationships among non-technical assets and entities to which assets belong.

19. The system of claim 14 in which an event is a cyber-security breach.

20. The system of claim 14 in which the user is legally associated with the entity.

21. The method of claim 14 in which the sub-entity is related to multiple entities.

22. The system of claim 14 in which the sub-entities reflect one or more of a business unit structure, business relationship structure, geographical grouping, and an asset type grouping.

23. The system of claim 14 in which publicly available data comprises data that is commercially available.

24. The system of claim 14 in which the online portal comprises an application programming interface.

25. The system of claim 14 in which the online portal receives data manually entered by a user via electronic messaging.

26. The system of claim 14 in which the online portal receives data via an automated update process.
